(19) United States
(12) Patent Application Publication
(10) Pub. No.: US 2018/0373576 A1
(43) Pub. Date: Dec. 27, 2018

(54) INFORMATION PROCESSING METHOD, DEVICE, SYSTEM, AND TERMINAL DEVICE

(71) Applicant: Alibaba Group Holding Limited, George Town (KY)

(72) Inventor: Wei Yao, Beijing (CN)

(21) Appl. No.: 16/000,547

(22) Filed: Jun. 5, 2018

Related U.S. Application Data
(63) Continuation of application No. PCT/CN2016/107407, filed on Nov. 28, 2016.

(30) Foreign Application Priority Data
Dec. 8, 2015 (CN) 201510896592.4

(51) Int. Cl. G06F 9/54; G06F 9/451; G06F 17/24; G06F 3/0482

(52) U.S. Cl. CPC G06F 9/543; G06F 3/0482; G06F 17/24; G06F 9/453

(57) ABSTRACT

Information processing is disclosed including determining an information type of target information, providing a processing interface for an extended function based on the information type, receiving a trigger instruction for an operation portal, sending the target information to an application supporting the extended function or a server based on the trigger instruction, and presenting the results of the application processing the target information.

### CROSS REFERENCE TO OTHER APPLICATIONS

This application is a continuation of and claims priority to International (PCT) Application No. PCT/CN16/107407 entitled METHOD, MEANS, SYSTEM, AND TERMINAL DEVICE FOR PROCESSING INFORMATION, filed Nov. 28, 2016 which is incorporated herein by reference for all purposes, which claims priority to People's Republic of China Patent Application No. 201510896592.4 entitled METHOD, MEANS, SYSTEM, AND TERMINAL DEVICE FOR PROCESSING INFORMATION, filed Dec. 8, 2015 which is incorporated herein by reference for all purposes.

### FIELD OF THE INVENTION

The present application relates to an information processing method, device, system, and terminal device.

### BACKGROUND OF THE INVENTION

With the development of information technology, users can be in contact with a wide array of information. Depending on the application scenario, a user sometimes selects and copies relevant information from within a current application and then pastes the relevant information into another application for processing. The following scenarios are examples:

In one scenario, a user manually selects and copies a website address from a received text message and then pastes the website address into a browser to look up the relevant information. In another scenario, the user manually selects and copies information from an instant messaging application chat and then pastes the information into an e-commerce application to look up related information.

Clearly, current information-processing processes require users to manually switch between multiple applications to process the selected information. Usability and processing efficiency are greatly reduced as a result.

### SUMMARY OF THE INVENTION

The present application provides at least some of the following benefits.

One of the aspects of the present application relates to a process for information processing. This process implements an extended service for information processing, and the process enables the user to directly acquire extended function information relating to target information or to subject the target information to operational processing. The process thereby reduces switching between the relevant applications and increases information processing efficiency.

Another aspect of the present application relates to a device for information processing.

Yet, another aspect of the present application relates to a terminal device for information processing.

Yet, another benefit of the present application relates to a system for information processing.

A first embodiment of the present application includes a process for information processing, including: determining an information type of target information and providing a processing interface for a preset extended function.

The process for information processing determines an information type of target information and provides a processing interface for a preset extended function for the information type. The process thereby implements an extended service for processing information and the process enables the user to directly acquire extended function information relating to the target information or subjects the target information to operational processing. The process thereby reduces the need to switch between the relevant applications and increases information processing efficiency.

A second embodiment of the present application includes a device for information processing, comprising: a determining module for determining an information type of target information; and a processing module for providing a processing interface for a present extended function for the information type.

The device for information processing information determines an information type of target information and provides a processing interface for a preset extended function for the information type. The device thereby implements an extended service for information processing, and the device enables the user to directly acquire extended function information relating to the target information or subjects the target information to operational processing. The device thereby reduces the need to switch between the relevant applications and increases information processing efficiency.

A third embodiment of the present application includes a terminal device comprising an information processing terminal device.

The information processing terminal device determines an information type of target information and provides a processing interface for a preset extended function for the information type. The information processing terminal device thereby implements an extended service for processing information, and the terminal device enables the user to directly acquire extended function information relating to the target information or subjects the target information to operational processing. The information processing terminal device thereby reduces the need to switch between the relevant applications and increases information processing efficiency.

A fourth embodiment of the present application includes an information processing system, comprising: a server and a terminal device. The terminal device comprises a device for processing information as described above.

The information processing system determines an information type of target information and provides a processing interface for a preset extended function for the information type. The information processing system thereby implements an extended service for processing information, and the system enables the user to directly acquire extended function information relating to the target information or subjects the target information to operational processing. The information processing system thereby reduces the need to switch between the relevant applications and increases information processing efficiency.

### BRIEF DESCRIPTION OF THE DRAWINGS

Various embodiments of the invention are disclosed in the following detailed description and the accompanying drawings.

FIG. 1 is a flowchart of an embodiment of a process for processing information.

FIG. 2 is a flowchart of another embodiment of a process for processing information.

FIG. 3 is an interface illustration of an example of target information being processed.

FIG. 4 is an interface illustration of another example of target information being processed.

FIG. 5 is an interface illustration of an example of results presented by an extended function processing interface.

FIG. 6 is a structural diagram of an embodiment of an information processing device.

FIG. 7 is a structural diagram of another embodiment of an information processing device.

FIG. 8 is a structural diagram of an embodiment of an information processing system.

FIG. 9 is a functional diagram illustrating a programmed computer system for processing information.

### DETAILED DESCRIPTION

The invention can be implemented in numerous ways, including as a process; a device; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

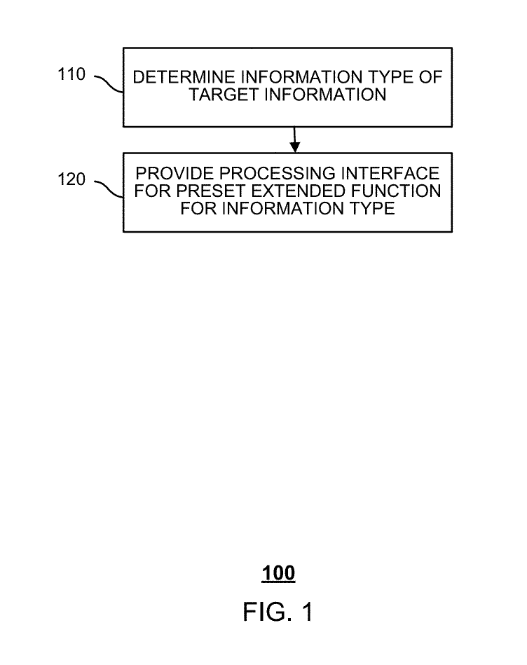

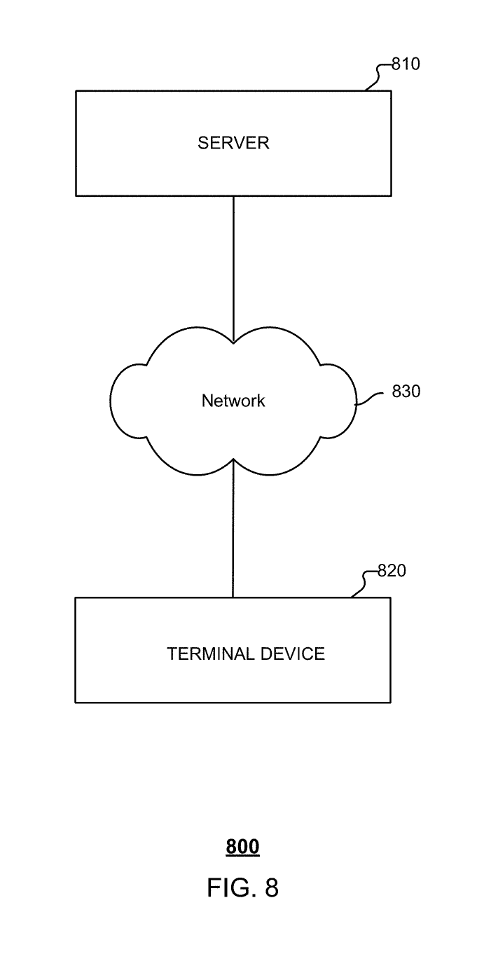

FIG. 1 is a flowchart of an embodiment of a process for processing information. In some embodiments, the process 100 is implemented by a terminal device 820 of FIG. 8 and comprises:

In 110, the terminal device determines an information type of target information.

In some embodiments, the process is implemented on the terminal device, such as a mobile phone, a tablet computer, a smart wearable device, or a computer, which supports installation of applications (“apps”). Installed applications can include: operating system applications such as cloud operating systems or other applications provided by service providers. Numerous types of the service providers can exist. For example, service providers include map service providers, e-businesses, audio and video service providers, search service providers, etc. Different service providers provide different applications.

In the event that, while using various applications, users perform another processing operation on information in the current application, the users are to select target information for processing.

Please note that many techniques exist for users to select the target information depending on user needs and application context. For example, a user chooses target information for processing using a selecting operation, a copying of selected text operation, or a cutting of selected text operation.

Then, in the event that the selection of the target information for processing has been detected, an information type of the target information can be determined based on, for example, matching the target information with certain classification rules.

It is understood that the target information can have a large amount of specific content. Target information having different content can correspond to a different information type. For example:

In the event that the selected target information is “Guggenheim,” the corresponding information type is proper noun.

In the event that the selected target information is “138110XXXXX,” the corresponding information type is telephone number.

In the event that the selected target information is “XX.jpeg,” the corresponding information type is image.

In the event that the selected target information is “www.XXX.com,” the corresponding information type is web address.

In the event that the selected target information is “Yonghe Temple,” the corresponding information type is proper noun.

In the event that the selected target information is “ [symbol] ” the corresponding information type is foreign language.

In the event that the selected target information is “20 US dollars,” the corresponding information type is monetary unit.

In the event that the selected target information is “XXX@163.com,” the corresponding information type is mailbox.

In the event that the selected target information is “December 2,” the corresponding information type is date.

In the event that the selected target information is “ [001] entire paragraph,” the corresponding information type is text segment.

It is pointed out that the above samples of target information are merely examples. The information type of the target information can be set flexibly based on application scenarios, and adjustments and refinements can be made according to different needs. For example, “proper noun” is subdivided into movie titles, song titles, names of scenic places, etc. There are no restrictions imposed in this regard.

It is understood that many techniques exist in which the information type of target information designated by a user is determined. One technique to determine the information type of target information can be selected or different techniques combined depending on the specific application scenario, as described via the examples below:

In one example, the information type of target information is determined based on preset correspondences between regular expressions and information types.

For example, with regard to regularly expressed target information, such as a web address or a telephone number, the information type of the target information can be determined based on the preset correspondences between the regular expressions and the information types.

A regular expression can correspond to a type of logical formula relating to string operations. Specific characters defined in advance and combinations of these specific characters can be used to compose a regular string literal, and the regular string literal can be used to express a filter logic for the string. For example, preset regular expressions include: a first regular expression corresponding to a web address type, a second regular expression corresponding to a telephone number type, a third regular expression corresponding to a formula type, and a fourth regular expression corresponding to a mailbox type.

The preset regular expressions can be used to filter-process the designated target information. If the filter result matches the first regular expression, then it is determined that the information type of the target information is “web address.” If the filter result matches the second regular expression, then it is determined that the information type of the target information is “telephone number.” The information types of other target information designated for processing can be determined in a similar manner.

In another example, the information type of target information is determined based on preset correspondences between characters and information types.

For example, regarding target information having special characters, such as a web address, a mailbox, a formula, a monetary unit, or a foreign language, the process determines the information type of the target information based on the preset correspondences between the characters and the information types. For example, the characters include: the characters “www.XYZ.com /www.XYZ.cn” corresponding to a web address type, the characters “+, −, *” corresponding to a formula type, and the characters “XYZ@XYZ.com/ XYZ@XYZ.cn” corresponding to a mailbox type.

The preset characters can be used to filter-process the designated target information. In the event that the filter results match “www.XYZ.com /www.XYZ.cn,” then the process determines that the information type of the target information is “web address.” In the event that the filter result matches “+, −, *,” then the process determines that the information type of the target information is “formula.” Information types of other target information designated for processing are determined based on the same logic.

In yet another example, the information type of target information is determined based on correspondences between pre-trained word banks and information types. In some embodiments, the determination is made using a machine learning technique to decide whether the target information is matches an information type.

As an example, regarding target information which is primarily expressed in text, the process determines the information type of the target information based on the correspondences between the pre-trained word banks and the information types. In some embodiments, the determination is made using a machine learning technique to decide whether the target information is matches an information type.

The pre-trained word banks can be differentiated into word banks for different contexts, e.g., movie titles, song titles, names of scenic places, proper nouns, polysemes, etc. As an example, a polyseme can be a coach, which can be a head coach of a team in one context or a bus in another context.

It is pointed out that the above are merely examples. In the present application, the information types of target information can be determined based on the designated target information using one or more of the approaches described above. No restrictions are imposed in this regard.

In 120, the terminal device provides a processing interface for a preset extended function for the information type.

For example, in order to provide users with extended function services relating to target information and in a comprehensively smart manner, extended functions associated with information types of target information are set up in advance. As an example, a system sets up the extended functions, or a system provides a user with a setup service so that the user can set up the extended functions based on habits and application needs of the user.

Please note that one or more extended functions can be set up for each information type. Selections and adjustments can be made based on actual conditions. For example:

In the event that the information type of the selected target information is “proper noun,” the extended function is set up as “search.”

In the event that the information type of the selected target information is “telephone number,” the extended functions are set up as “make telephone call” and “send text message.”

In the event that the information type of the selected target information is “image,” the extended functions are set up as “forward” and “add.”

In the event that the information type of the selected target information is “web address,” the extended function is set up as “load in background.”

In the event that the information type of the selected target information is “physical address,” the extended function is set up as “navigate in map.”

In the event that the information type of the selected target information is “foreign language,” the extended function is set up as “translate.”

In the event that the information type of the selected target information is “monetary unit,” the extended function is set up as a “currency conversion.”

In the event that the information type of the selected target information is “mailbox,” the extended function is set up as “send email.”

In the event that the information type of the selected target information is “name of application,” the extended function is set up as “download.”

In the event that the information type of the selected target information is “number,” the extended function is set up as “calculate.”

In the event that the information type of the selected target information is “date,” the extended function is set up as “keep journal.”

In the event that the information type of the selected target information is “text segment,” the extended function is set up as “add.”

It is pointed out that the above are merely examples. In some embodiments, the extended function for each information type is set up flexibly based on specific contexts.

Extended function processing interfaces are provided based on preset extended functions corresponding to information types of the target information. Please note that the extended function processing interfaces can be provided using many techniques depending on the application scenario. For example, the extended function processing interface is provided through a context menu of the current application interface, or the extended function processing interface is provided through a preset zone, the preset zone being set up based on a specific application interface or such factors as terminal device information types and dimensions. For example, the preset zone could be a zone on one side of a screen, or the preset zone could be a notification box zone.

Please note that content of extended function processing interfaces provided according to different application scenarios can differ.

For example, in some embodiments, the extended function processing interface includes an operation portal configured to invoke the extended function to process the target information. Through the operation portal of the processing interface, the user can directly instruct the extended function to process the target information.

In another example, the extended function processing interface comprises the results of the extended function-supporting application processing the target information. Through the processing interface, the user can directly view the results of the extended function-supporting application processing the target information.

The process for information processing determines an information type of target information and provides a processing interface for a preset extended function for the information type. The process thereby implements a preset extended service for processing information, and enables the user to directly acquire extended function information relating to the target information or to subject the target information to operational processing. The process thereby reduces the need to switch between the relevant applications and increases information processing efficiency.

Regarding operation 120, the specific content of the provided extended function processing interface and the operations performed by the user relating to the extended function processing interface are further explained.

In an example, the extended function processing interface in operation 120 includes: an operation port for instructing the extended function to process the target information.

For example, the operation port for instructing the extended function is provided through the processing interface based on the extended function corresponding to the information type of the target information. Different extended functions correspond to different operation ports. As a result, the user can use different operation ports to instruct corresponding extended functions to process the target information.

For example:

In the event that the information type of the selected target information is “foreign language,” the extended function is set up as “translate” and a provided operation portal is set up as “translate target information.” A server, the operating system (OS), an administrator, a user, an application, etc. can set up the extended function.

In the event that the information type of the selected target information is “text segment,” the extended function is set up as “add” and a provided operation portal is set up as: “add target information to scratchpad.”

In the event that the information type of the selected target information is “proper noun,” the extended function is set up as “search” and a provided operation portal is set up as: “search for target information.”

In the event that the information type of the selected target information is “telephone number,” the extended functions are set up as “make telephone call” and “send text message” and provided operation portals are set up as: “send text message to target information” and “make telephone call to target information.”

It is pointed out that the above are merely examples. In some embodiments, the operation portal for instructing the extended function to process the target information provided in the extended function processing interface is set up flexibly in accordance with specific scenarios.

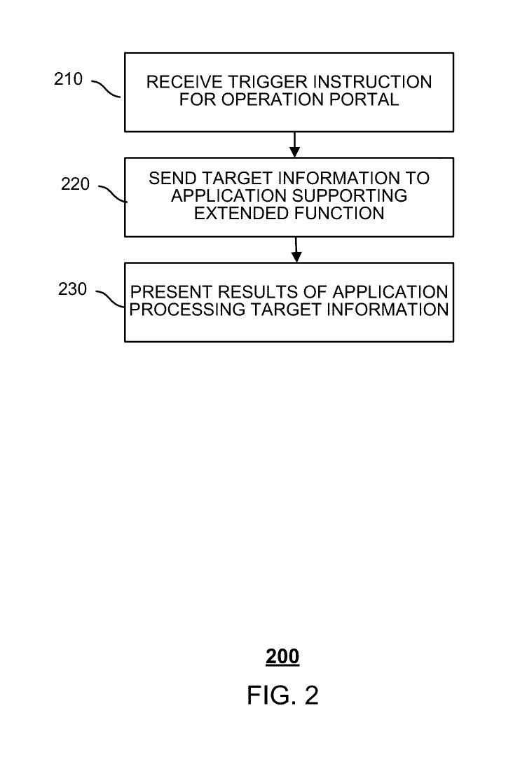

Thereupon, the user, via the operation portal, can instruct the corresponding extended function to process the target information. For example, the instructing includes the operations shown in FIG. 2.

FIG. 2 is a flowchart of another embodiment of a process for processing information. In some embodiments, the process 200 is implemented after performing operation 120 of FIG. 1 and comprises:

In 210, the terminal device receives a trigger instruction for an operation portal. In some embodiments, the trigger instruction corresponds to a user click, a press operation, or some other operations.

In 220, the terminal device sends the target information to an application supporting an extended function based on the trigger instruction.

In 230, the terminal device presents results of the application processing the target information.

For example, in the event that the trigger instruction directed by the user at the operation portal in the extended function processing interface is received, the terminal device sends the target information to an application supporting the extended function based on the trigger instruction.

Please note that since extended functions differ, applications that support extended functions also differ. The appropriate processing can be performed based on a specific extended function and terminal-supported application. This processing can be explained by the following examples:

The target information is sent to a local application corresponding to the application for appropriate processing, the target information is sent to a server corresponding to the application to acquire processing results corresponding to the target information that were generated by the server based on background data, or the target information is sent to a client corresponding to the application to acquire processing results corresponding to the target information that was generated by the client based on background data.

Subsequently, the results of processing the target information by the application supporting the extended function are presented. Please note that operation processing results can be presented to the user using many techniques based on specific application operating processes. For example:

The results of processing target information by the relevant application are presented through a context menu, the results of processing target information by the relevant application are presented through a preset zone, or an interface for processing the target information by the application is presented.

The following examples are provided to explain how an extended function-supporting application is instructed via an operating portal to process target information and present the operation results.

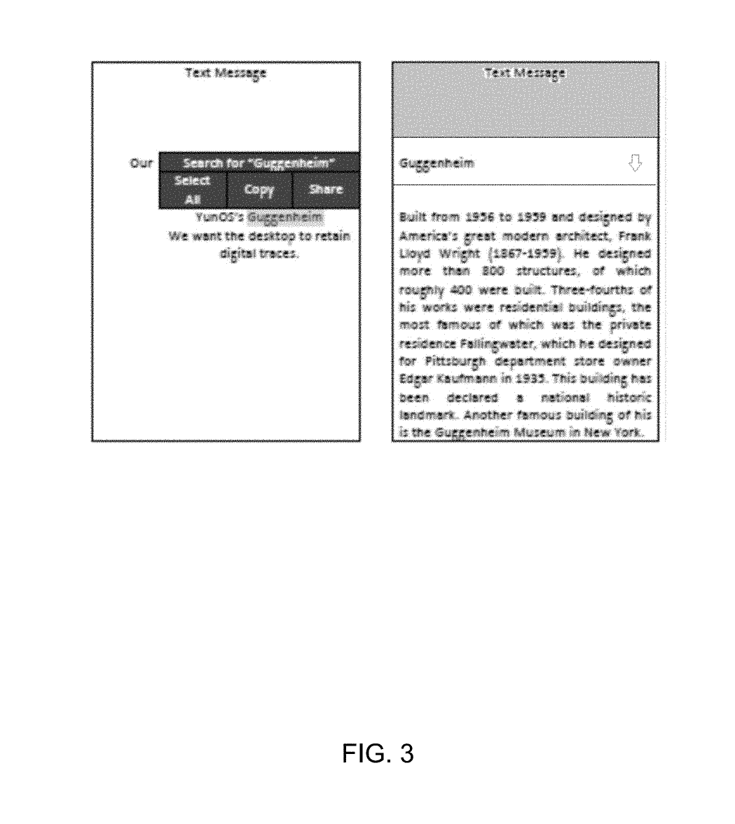

FIG. 3 is an interface illustration of an example of target information being processed. The left and right sides are shown in separate windows, as shown in FIG. 3. In some embodiments, the right side is displayed in a floating window or a popup window above the left text window.

In the interface illustration of FIG. 3, the selected target information is “Guggenheim,” and it is determined that the information type of the target information “Guggenheim” is “proper noun,” for which the preset extended function is “search.”

The extended function processing interface provided to the user then includes: an operation portal to search for “Guggenheim,” as shown in the left side of FIG. 3.

If the user is to search for “Guggenheim,” the user then triggers the operation portal to search for “Guggenheim.” The operation portal sends “Guggenheim” to a client or server that supports the extended function based on the trigger instruction. The client or server generates search results based on background data corresponding to “Guggenheim” and presents the search results to the user, as shown in the right side of FIG. 3. In some embodiments, the background data can be the search database.

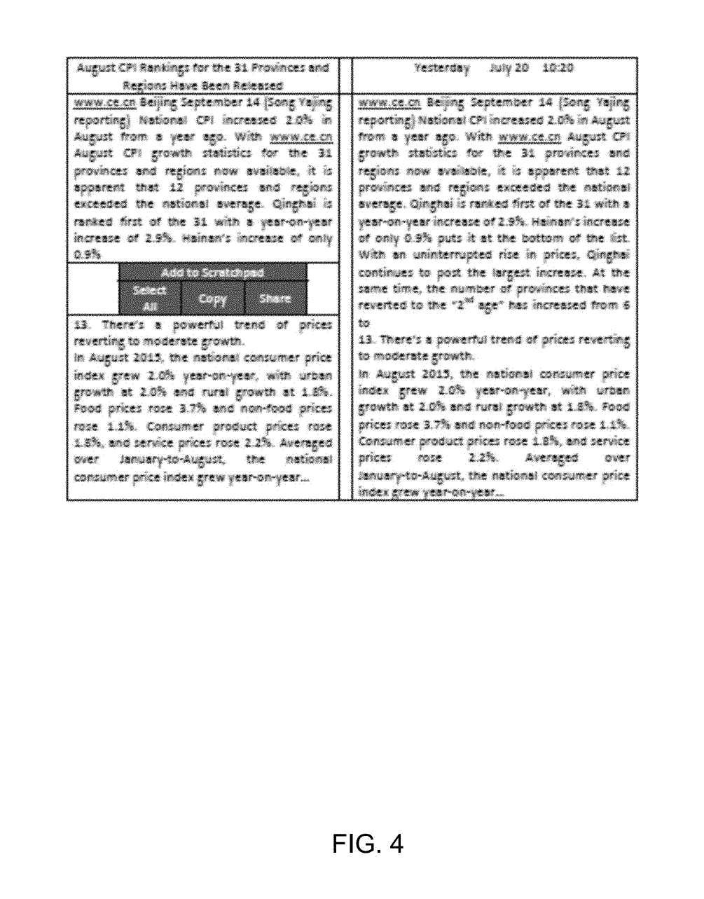

FIG. 4 is an interface illustration of another example of target information being processed.

In the interface illustration of FIG. 4, the selected target information is the text segment shown on the left side of FIG. 4. The corresponding information type is confirmed as “text segment,” for which the preset extended function is “add.”

The extended function processing interface provided to the user then includes: an operation portal for adding a text segment to the scratchpad/text editor, as shown on the left side of FIG. 4.

If the user is to add the selected text segment to the scratchpad, then the user triggers the operation portal for adding the text segment to the scratch pad by selecting the “add to scratchpad” option. The text segment selected by the user is sent to the local application scratchpad, and a scratchpad interface with the text segment added is presented based on the trigger instruction, as shown on the right side of FIG. 4.

The extended function processing interface provided by the process for processing information includes: an operation portal configured to instruct an extended function to process target information, sending the target information to an application supporting the extended function based on the trigger instruction, and presenting the results of the application processing the target information. The process thereby implements an extended service configured to process information, and enables the user to directly instruct the extended function to process the target information and acquire the processing results. The process thus reduces the need to switch between the relevant applications and increases information processing efficiency.

In another example, the extended function processing interface in operation 120 of FIG. 1 includes: the results of the extended function-supporting application processing the target information.

For example, for each extended function, one or more applications supporting that extended function are set up. In yet another example, for each terminal-supported application (a locally installed application or a web application), an extended function supported by the application is set up. For example, correspondences are established between preconfigured extended functions and applications. One extended function can correspond to one or more applications, and one application can also correspond to one or more extended functions. Different extended functions can correspond to different supporting applications. For example, based on the supported extended functions, the applications include at least one of the following: search engine (supported extended functions include “search”), translation (supported extended functions include “translate”), calculator (supported extended functions include “calculate”), currency conversion (supported extended functions include “currency conversion”), telephone (supported extended functions include “make telephone call”), text messaging (supported extended functions include “send text message”), mailbox (supported extended functions include “send mail”), application center (supported extended functions include “download”), video (supported extended functions include “play video”), scratchpad (supported extended functions include “add”), etc.

After the target information is sent to the relevant application supporting the extended function, the relevant application processes the target information and provides the processing results as feedback. Then, the results of the extended function application processing the target information are provided directly through the extended function processing interface so that the user can view the processing results through the processing interface without having to switch between applications. In the event that one extended function corresponds to multiple applications, one of the multiple applications can be selected to process the current target information. This selection can be based on a preset rule (e.g., the application that is the most frequently used by user/most recently opened/uses the least resources is selected), or the selection can be random. There is no restriction imposed on the selection.

Please note that since different applications correspond to different executing entities, the process whereby a supporting application processes target information and provides processing results as feedback can be selected according to application need. For example:

The target information can be sent to a server supporting the extended function to acquire processing results corresponding to the target information that are generated by the server based on background data. For example:

In the event that the selected target information is “Guggenheim” and the information type is “proper noun,” the extended function is set up as “search.” “Guggenheim” is sent to a server that supports the extended function of search. The server generates background data-based search results corresponding to “Guggenheim.”

In the event that the selected target information is “Yonghe Temple,” and the information type is “name of scenic place,” the extended function can be set up as “navigate.” “Yonghe Temple” is sent to a client such as a map application supporting navigation. The client, based on background data, generates navigation information (e.g., driving directions) corresponding to “Yonghe Temple.”

The target information can be sent to a local application supporting the extended function application. The local application processes the target information based on pre-saved data to acquire corresponding processing results. For example:

In the event that the selected target information is “130 US dollars” and the information type is “monetary unit,” the extended function can be set up as “currency conversion.” “130 US dollars” is sent to the local currency conversion application. The local application, based on the pre-saved data, generates a currency conversion result in local currency that corresponds to “130 US dollars.”

Furthermore, it is pointed out that the processing results can have a great deal of content and thus full display of the processing results could utilize a large processing interface zone. Therefore, in some embodiments, in order to conserve processing resources and improve user experience, the processing results can be analyzed to acquire key words from the processing results, and then, through a processing interface, provide expanded operation portals marked with the processing result key words.

Given different extended functions and applications, different processing techniques can be employed to acquire processing result key words.

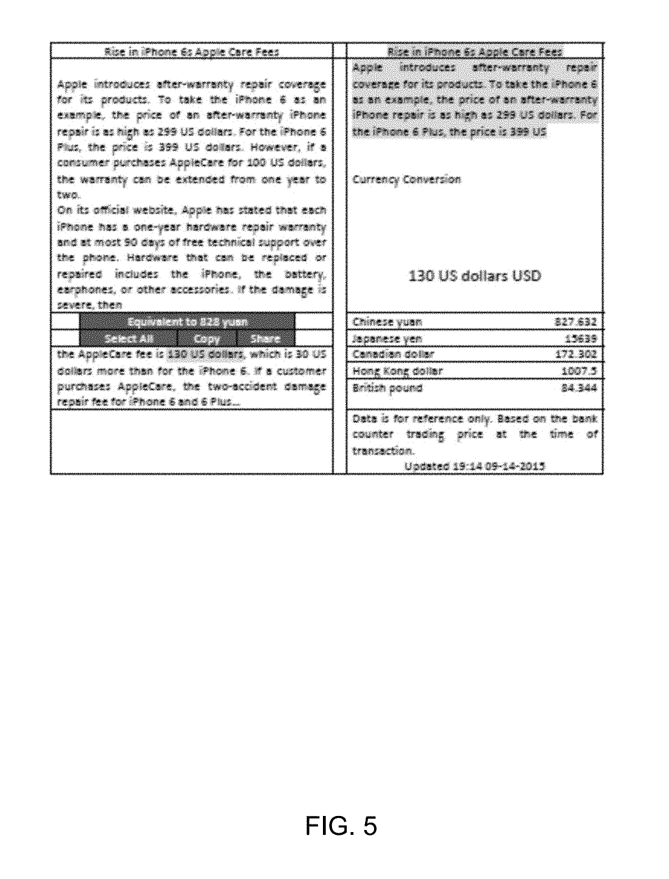

FIG. 5 is an interface illustration of an example of results presented by an extended function processing interface. FIG. 5 is described below:

The target information selected by the user is “130 US dollars,” and the information type for “130 US dollars” is set up as “monetary unit,” for which the preset extended function is “currency conversion.” “130 US dollars” is sent to the local currency conversion application or to a server or client that supports a currency conversion function to acquire currency conversion results corresponding to “130 US dollars” generated by a corresponding executing entity based on the corresponding data.

Processing result key words, i.e., “equivalent to 828 yuan,” matched to the system language are acquired from the currency conversion results. The extended function processing interface provided to the user includes: an expanded operation portal marked with “equivalent to 828 yuan,” as shown in the left side of FIG. 5.

In the event that the user is to acquire renminbi currency conversion results, the user can acquire the currency conversion results directly from the extended function processing interface. In the event that the user also is to acquire currency conversion results for other countries, then the user triggers the expanded operation portal. Based on the trigger instruction, the user is provided with the currency conversion results corresponding to “130 US dollars USD” for all countries, as shown in the right side of FIG. 5.

The extended function processing interface provided by the process for processing information includes: the results of the extended function-supporting application processing the target information to enable the user to acquire the extended function processing results directly through a processing interface. The process thereby implements an extended service for processing information. The process thus reduces the need to switch between the relevant applications and increases information processing efficiency.

Furthermore, the process for processing information can also include providing a basic function operation portal corresponding to the target information.

The basic function includes at least one of the following: “Select All,” “Copy,” or “Share,” as shown on the left sides of FIGS. 3-5.

Furthermore, it is pointed out that, after copying text to a clipboard, the copied text corresponds to the target information, and the above processing operation for the target information is to be performed.

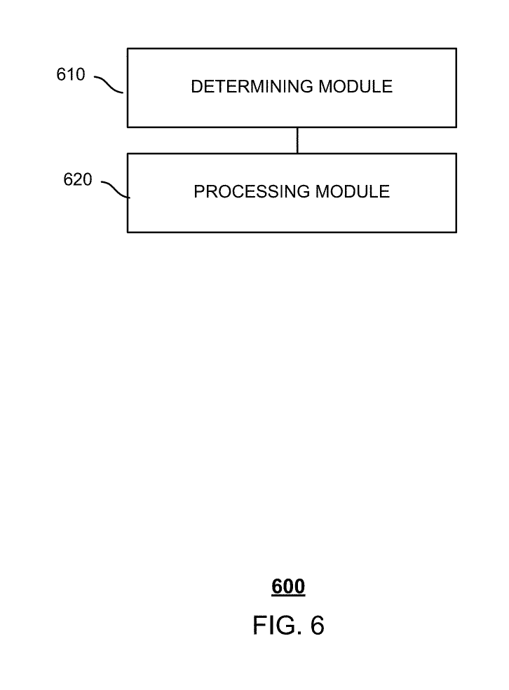

FIG. 6 is a structural diagram of an embodiment of an information processing device. In some embodiments, the device 600 is configured to perform process 100 of FIG. 1 and includes a determining module 610 and a processing module 620.

In some embodiments, the determining module 610 is configured to determine the information type of target information.

For example, the target information includes the target information selected by a selecting operation, a copying operation, or a cutting operation.

The information type includes at least one of the following: proper noun, picture, web address, monetary unit, formula, telephone number, date, time, mailbox, weight, measurement, foreign language, physical address, or text segment.

It is understood that many techniques in which the information type of target information designated by a user can be determined. One technique can be selected or different techniques combined depending on the specific application scenario, as explained through the examples below:

In a first example, the determining module 610 is configured to determine the information type of target information based on preset correspondences between regular expressions and information types.

In a second example, the determining module 610 is configured to determine the information type of target information based on preset correspondences between characters and information types.

In a third example, the determining module 610 is configured to determine the information type of target information based on correspondences between pre-trained word banks and information types.

The processing module 620 is configured to provide a processing interface for a preset extended function for the information type.

As an example, in order to provide users with extended function services relating to target information and in a comprehensively smart manner, in advance, extended functions associated with information types of target information are set up. As an aspect, a system can set up the extended functions, or a system can provide a user with a setup service so that the user can set up the extended functions based on their own use habits and application needs.

Please note that one or multiple extended functions can be set up for each information type. Selections and adjustments can be made based on actual conditions. For example, the extended functions include at least one of the following: search, translate, calculate, download, currency conversion, play video, make telephone call, send text message, forward, or add.

Extended function processing interfaces can be provided based on preset extended functions corresponding to information types of target information. Please note that the extended function processing interfaces can be provided in many ways depending on the application scenario. For example:

In a first example, the processing module 620 is configured to provide the extended function processing interface through a context menu of a current application interface.

In a second example, the processing module 620 is configured to provide the extended function processing interface through a preset zone. In some embodiments, the preset zone is set up based on a specific application interface or such factors as terminal device information type and dimensions. For example, the preset zone corresponds to a zone on one side of a screen, or the preset zone corresponds to a notification box zone.

It is pointed out that the content of the extended function processing interfaces provided based on different application scenarios can differ.

In one example, the extended function processing interface includes an operation portal for instructing the extended function to process the target information, and enabling the user, directly through the operation portal of the processing interface, to instruct the extended function to process the target information.

In another example, the extended function processing interface includes the results of the extended function-supporting application processing the target information, and enables the user, directly through the processing interface, to view the results of the extended function-supporting application processing the target information.

It is pointed out that the explanations of the processes for information processing above also apply to information processing devices and will not be further discussed for conciseness.

The device for processing information determines information type of target information and provides a processing interface for a preset extended function for the information type. The device thereby implements an extended service for processing information, and enables the user to directly acquire extended function information relating to the target information or to subject the target information to operational processing. The device thereby reduces the need to switch between the relevant applications and increases information processing efficiency.

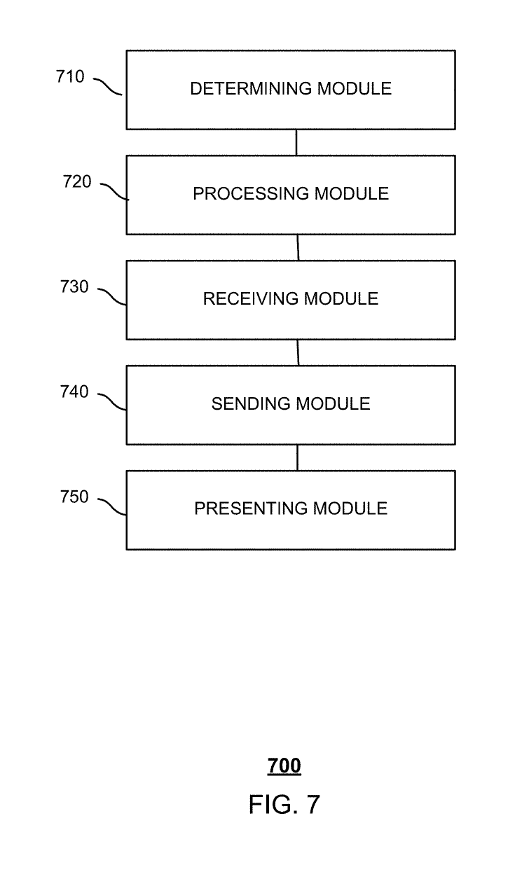

FIG. 7 is a structural diagram of another embodiment of an information processing device. In the some embodiments, the device 700 is configured to implement the process 200 of FIG. 2 and includes a determining module 710, a processing module 720, a receiving module 730, a sending module 740, and a presenting module 750.

In some embodiments, the determining module 710 corresponds to the determining module 610 of FIG. 6 and the processing module 720 corresponds to the processing module 620 of FIG. 6.

In some embodiments, the device 700 includes a processing interface that includes an operation portal for instructing an extended function to process target information.

In some embodiments, the receiving module 730 is configured to receive a trigger instruction for an operation portal.

In some embodiments, the sending module 740 is configured to send the target information to an application supporting the extended function based on the trigger instruction.

As an example, in the event that the trigger instruction directed by the user at the operation portal in the extended function processing interface is received, the device, based on the trigger function, sends the target information to an application supporting the extended function.

Please note that since extended functions differ, applications that support the extended functions can also differ. The appropriate processing can be performed based on a specific extended function and terminal-supported application. This appropriate processing can be explained by the following examples:

In a first example, the sending module 740 is configured to send the target information to a server or client corresponding to the application to acquire processing results corresponding to the target information that were generated by the server or client based on background data.

In a second example, the sending module 740 is configured to send the target information to a local application corresponding to the application.

In some embodiments, the presenting module 750 is configured to present the results of the application processing the target information.

Please note that operation processing results can be presented to the user in many ways based on specific application operating processes.

In a first example, the presenting module 750 presents the processing results through a context menu.

In a second example, the presenting module 750 presents the processing results through a preset zone.

In a third example, the presenting module 750 presents an application interface relating to the processing of the target information.

Please note that the descriptions of the process for processing information presented above also apply to the device for processing information and are not to be further discussed.

The extended function processing interface provided by the device for processing information includes: an operation portal for instructing an extended function to process target information, sending target information to an application supporting the extended function based on the trigger instruction directed at the operation portal, and presenting the results of the application processing the target information. The device thereby implements an extended service for processing information, and enables the user to directly instruct an extended function to process the target information and acquire the processing results. The device thus reduces the need to switch between the relevant applications and increases information processing efficiency.

In some embodiments, as shown in FIG. 6, the extended function processing interface provided by the processing module 620 includes the results of the extended function-supporting application processing the target information.

As an example, one or more applications supporting extended functions are set up in advance. In some embodiments, different extended functions correspond to different supporting applications. For example, the applications include at least one of the following: search engine, translation, calculator, currency conversion, telephone, text messaging, mailbox, app center, video, or scratchpad.

After the target information is sent to the relevant application supporting the extended function, the relevant application processes the target information and provides the processing results as feedback. Subsequently, the results of the extended function application processing the target information are provided directly through the extended function processing interface so that the user can view the processing results through the processing interface without having to switch between applications.

Please note that since different applications correspond to different executing entities, the process whereby a supporting application processes target information and provides processing results as feedback can be selected according to application need.

Furthermore, please note that the processing results can have a great deal of content and thus full display of the processing results could take up a large processing interface zone. Therefore, in order to conserve processing resources and improve user experience, analyzing the processing results can occur to acquire key words from the processing results, and then, through a processing interface, provide expanded operation portals marked with the processing result key words.

Please note that, given different extended functions and applications, different processing techniques can be employed to acquire the processing result key words.

The extended function processing interface provided by the device for processing information includes: presenting the results of the extended function-supporting application processing the target information, and enabling the user to acquire the extended function processing results directly through a processing interface. The device thereby implements an extended service for processing information. The device thus reduces the need to switch between the relevant applications and increases information processing efficiency.

Furthermore, the processing module 720 is further configured to provide a basic function operation portal corresponding to the target information. The basic function comprises at least one of the following: select all, copy, share, etc.

Furthermore, it is pointed out that, after copying text to a clipboard, the copied text is equivalent to the target information, and the processing operations for the target information are to be executed.

The modules described above can be implemented as software components executing on one or more general purpose processors, as hardware such as programmable logic devices and/or Application Specific Integrated Circuits designed to perform certain functions, or a combination thereof. In some embodiments, the modules can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The modules may be implemented on a single device or distributed across multiple devices. The functions of the modules may be merged into one another or further split into multiple sub-modules.

The methods or algorithmic steps described in light of the embodiments disclosed herein can be implemented using hardware, processor-executed software modules, or combinations of both. Software modules can be installed in random-access memory (RAM), memory, read-only memory (ROM), electrically programmable ROM, electrically erasable programmable ROM, registers, hard drives, removable disks, CD-ROM, or any other forms of storage media known in the technical field.

To implement the above processing, the present application also describes a terminal device.

The terminal device determines an information type of target information and provides a processing interface for an extended function for the information type. The terminal device thereby implements an extended service for processing information, and the terminal device enables the user to directly acquire extended function information relating to the target information or to subject the target information to operational processing. The terminal device thereby reduces the need to switch between the relevant applications and increases information processing efficiency.

In some embodiment, the present application also includes a system for processing information.

FIG. 8 is a structural diagram of an embodiment of an information processing system. In some embodiments, the system 800 includes: a server 810 connected via a network 830 to a terminal device 820.

The system 800 for processing information determines an information type of target information and provides a processing interface for a preset extended function for the information type. The system 800 thereby implements an extended service for processing information, and enables the user to directly acquire extended function information relating to the target information or to subject the target information to operational processing. The system thereby reduces the need to switch between the relevant applications and increases information processing efficiency.

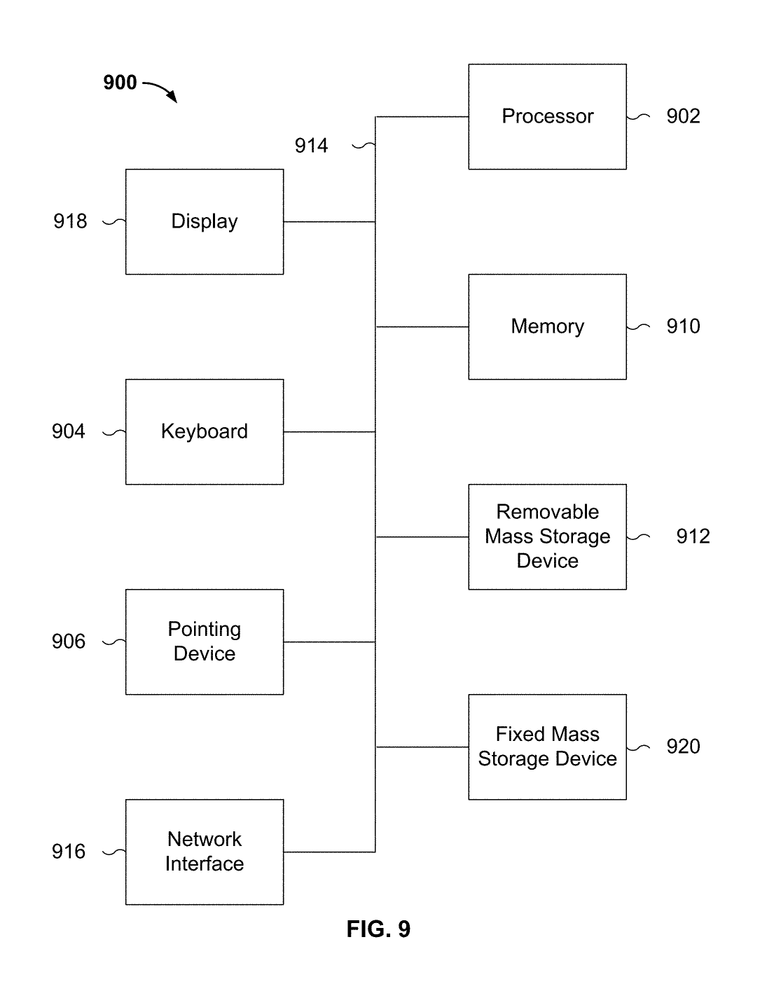

FIG. 9 is a functional diagram illustrating a programmed computer system for processing information. As will be apparent, other computer system architectures and configurations can be used to perform information processing. Computer system 900, which includes various subsystems as described below, includes at least one microprocessor subsystem (also referred to as a processor or a central processing unit (CPU)) 902. For example, processor 902 can be implemented by a single-chip processor or by multiple processors. In some embodiments, processor 902 is a general purpose digital processor that controls the operation of the computer system 900. Using instructions retrieved from memory 910, the processor 902 controls the reception and manipulation of input data, and the output and display of data on output devices (e.g., display 918).

Processor 902 is coupled bi-directionally with memory 910, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 902. Also as is well known in the art, primary storage typically includes basic operating instructions, program code, data and objects used by the processor 902 to perform its functions (e.g., programmed instructions). For example, memory 910 can include any suitable computer-readable storage media, described below, depending on whether, for example, data access needs to be bi-directional or uni-directional. For example, processor 902 can also directly and very rapidly retrieve and store frequently needed data in a cache memory (not shown).

A removable mass storage device 912 provides additional data storage capacity for the computer system 900, and is coupled either bi-directionally (read/write) or uni-directionally (read only) to processor 902. For example, storage 912 can also include computer-readable media such as magnetic tape, flash memory, PC-CARDS, portable mass storage devices, holographic storage devices, and other storage devices. A fixed mass storage 920 can also, for example, provide additional data storage capacity. The most common example of mass storage 920 is a hard disk drive. Mass storages 912 and 920 generally store additional programming instructions, data, and the like that typically are not in active use by the processor 902. It will be appreciated that the information retained within mass storages 912 and 920 can be incorporated, if needed, in standard fashion as part of memory 910 (e.g., RAM) as virtual memory.

In addition to providing processor 902 access to storage subsystems, bus 914 can also be used to provide access to other subsystems and devices. As shown, these can include a display monitor 918, a network interface 916, a keyboard 904, and a pointing device 906, as well as an auxiliary input/output device interface, a sound card, speakers, and other subsystems as needed. For example, the pointing device 906 can be a mouse, stylus, track ball, or tablet, and is useful for interacting with a graphical user interface.

The network interface 916 allows processor 902 to be coupled to another computer, computer network, or telecommunications network using a network connection as shown. For example, through the network interface 916, the processor 902 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 902 can be used to connect the computer system 900 to an external network and transfer data according to standard protocols. For example, various process embodiments disclosed herein can be executed on processor 902, or can be performed across a network such as the Internet, intranet networks, or local area networks, in conjunction with a remote processor that shares a portion of the processing. Additional mass storage devices (not shown) can also be connected to processor 902 through network interface 916.

An auxiliary I/O device interface (not shown) can be used in conjunction with computer system 900. The auxiliary I/O device interface can include general and customized interfaces that allow the processor 902 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 9 is but an example of a computer system suitable for use with the various embodiments disclosed herein. Other computer systems suitable for such use can include additional or fewer subsystems. In addition, bus 914 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
determining an information type of target information, wherein the target information is selected by a user in a current interface;
providing a processing interface for an extended function based on the information type, wherein the processing interface for the extended function for the information type comprises an operation portal for instructing the extended function to process the target information;
receiving a trigger instruction for the operation portal;
sending the target information to an application supporting the extended function or a server based on the trigger instruction; and
presenting results of the application processing the target information.

2. The method as described in claim 1, wherein:
the target information comprises target information selected by a selecting operation, a copying of selected text operation, or a cutting of selected text operation; and
the information type comprises at least one of the following:
a proper noun, an image, a web address, a monetary unit, a formula, a telephone number, a date, a time, a mailbox, a weight, a measurement, a foreign language, a physical address, and/or a text segment.

3. The method as described in claim 1, wherein the determining of the information type of the target information comprises:
performing one or more of the following:
determining the information type of the target information based on preset correspondences between regular expressions and information types;
determining the information type of the target information based on preset correspondences between characters and information types; and/or
determining the information type of the target information based on correspondences between pre-trained word banks and information types.

4. The method as described in claim 1, wherein the providing of the processing interface for the extended function for the information type comprises:
providing the processing interface for the extended function through a context menu; or
providing the processing interface for the extended function through a preset zone.

5. The method as described in claim 1, wherein the extended function includes at least one of the following:
search, translate, calculate, download, currency conversion, play video, make telephone call, send text message, and/or forward.

6. The method as described in claim 1, wherein the sending of the target information to the application supporting the extended function comprises:
sending the target information to a server or client corresponding to the application to acquire processing results corresponding to the target information that were generated by the server or client based on background data; or sending the target information to a local application corresponding to the application.

7. The method as described in claim 1, wherein the presenting of the results of the application processing the target information comprises:
presenting the processing results through a context menu;
presenting the processing results through a preset zone; or
presenting an application interface relating to the processing of the target information.

8. The method as described in claim 1, wherein the processing interface for the extended function comprises:
the results of processing the target information by the application supporting the extended function.

9. The method as described in claim 8, wherein the application includes at least one of the following:
search engine, translation, calculator, currency conversion, telephone, text messaging, mailbox, app center, video, or scratchpad.

10. The method as described in claim 8, wherein the processing results comprise:
expanded operation portals marked with processing result key words.

11. The method as described in claim 1, further comprising:
providing an operation portal for a basic function corresponding to the target information.

12. The method as described in claim 11, wherein the basic function includes select all, copy, share, or any combination thereof.

13. A system, comprising:
a processor; and
a memory coupled with the processor, wherein the memory is configured to provide the processor with instructions which when executed cause the processor to:
determine an information type of target information, wherein the target information is selected by a user in a current interface;
provide a processing interface for an extended function based on the information type, wherein the processing interface for the extended function for the information type comprises an operation portal for instructing the extended function to process the target information;
receive a trigger instruction for the operation portal;
send the target information to an application supporting the extended function or a server based on the trigger instruction; and
present results of the application processing the target information.

14. The system as described in claim 13, wherein:
the target information comprises:
target information selected by a selecting operation, a copying of selected text operation, or a cutting of selected text operation; and
the information type comprises at least one of the following:
a proper noun, an image, a web address, a monetary unit, a formula, a telephone number, a date, a time, a mailbox, a weight, a measurement, a foreign language, a physical address, and/or a text segment.

15. The system as described in claim 13, wherein the determining of the information type of the target information comprises to:
perform one or more of the following:
determine the information type of the target information based on preset correspondences between regular expressions and information types;
determine the information type of the target information based on preset correspondences between characters and information types; and/or
determine the information type of the target information based on correspondences between pre-trained word banks and information types.

16. The system as described in claim 13, wherein the providing of the processing interface for the extended function for the information type comprises to:
provide the processing interface for the extended function through a context menu; or
provide the processing interface for the extended function through a preset zone.

17. The system as described in claim 14, wherein the extended function includes at least one of the following:
search, translate, calculate, download, currency conversion, play video, make telephone call, send text message, and/or forward.

18. The system as described in claim 13, wherein the sending of the target information to the application supporting the extended function comprises to:
send the target information to a server or client corresponding to the application to acquire processing results corresponding to the target information that were generated by the server or client based on background data; or
send the target information to a local application corresponding to the application.

19. The system as described in claim 13, wherein the presenting of the results of the application processing the target information comprises to:
present the processing results through a context menu;
present the processing results through a preset zone; or
present an application interface relating to the processing of the target information.

20. The system as described in claim 13, wherein the processing interface for the extended function comprises:
the results of processing the target information by the application supporting the extended function.

21. The system as described in claim 20, wherein the application includes at least one of the following:
search engine, translation, calculator, currency conversion, telephone, text messaging, mailbox, app center, video, or scratchpad.

22. The system as described in claim 20, wherein the processing results comprise:
expanded operation portals marked with processing result key words.

23. The system as described in claim 13, wherein the processor is further configured to:
provide an operation portal for a basic function corresponding to the target information.

24. The system as described in claim 23, wherein the basic function includes select all, copy, share, or any combination thereof.

25. A computer program product being embodied in a tangible non-transitory computer readable storage medium and comprising computer instructions for:
determining an information type of target information, wherein the target information is selected by a user in a current interface;
providing a processing interface for an extended function based on the information type, wherein the processing interface for the extended function for the information type comprises an operation portal for instructing the extended function to process the target information;
receiving a trigger instruction for the operation portal;
sending the target information to an application supporting the extended function or a server based on the trigger instruction; and
presenting results of the application processing the target information.
